(19) United States
(12) Patent Application Publication
(10) Pub. No.: US 2007/0059658 A1
(43) Pub. Date: Mar. 15, 2007

(54) Bondforce device

(75) Inventor: Andrew Michael Nalin, Bossier City, LA (US)

Correspondence Address: MR. Charles David Nalin, 6654 Oakshire Court, Newburgh, IN, 47630, US

(73) Assignee: Andrew Michael Nalin, Bossier City, LA (US)

(21) Appl. No.: 11/224,562

(22) Filed: Sep. 13, 2005

(51) Int. Cl. A61C 3/00

(52) U.S. Cl. 433/3; 433/75

(57) ABSTRACT

A portable handheld electrical Bondforce device including a 3M Debracketing Tool is connected to a measuring device capable of translating millvolt signals into measurable and readable pound units. The measuring device captures the readings and displays them to the user in near real time.

Direct bonding of metal orthodontic brackets to enamel with acid etch technique and composite resin, as first described in 1965, has essentially been the preferred method of attaching orthodontic appliances to teeth since the late 1970's. In the last 40 years materials have evolved and countless products have been introduced into the marketplace with the goal of making bonding easier, faster, and strong enough to withstand the forces of mastication over the length of treatment but not damage the enamel when debonding.

Traditionally, orthodontic adhesives have been tested in vitro on extracted teeth, using a universal testing machine to debond brackets with a shear, tensile, or torsional force, and measuring the peak force until bond failure. There has been no way to measure force levels necessary to debond brackets in the oral environment.

It would be preferable to be able to measure bond strengths by utilizing a handheld force-measuring device as part of the patient's treatment environment.

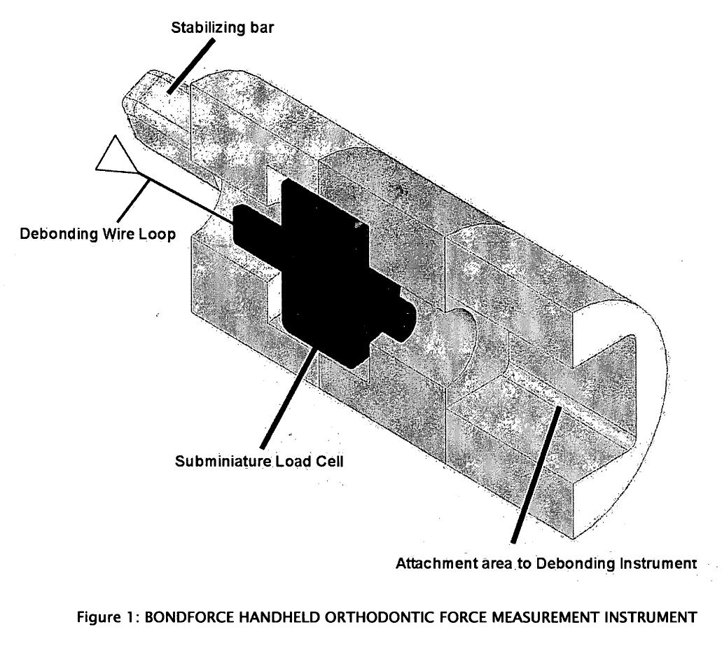

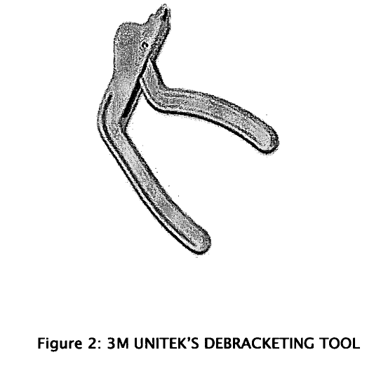

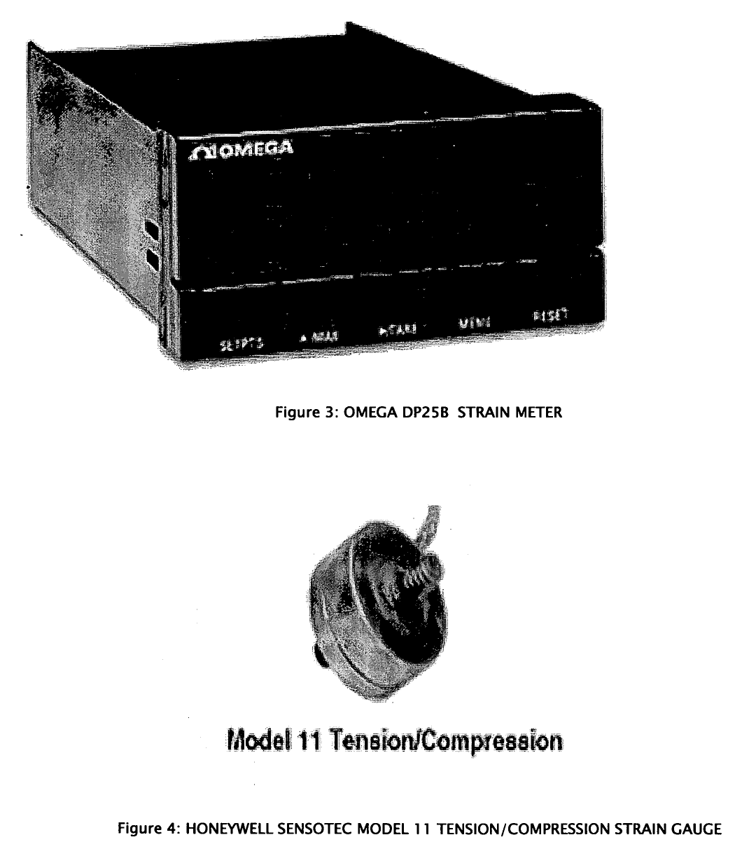

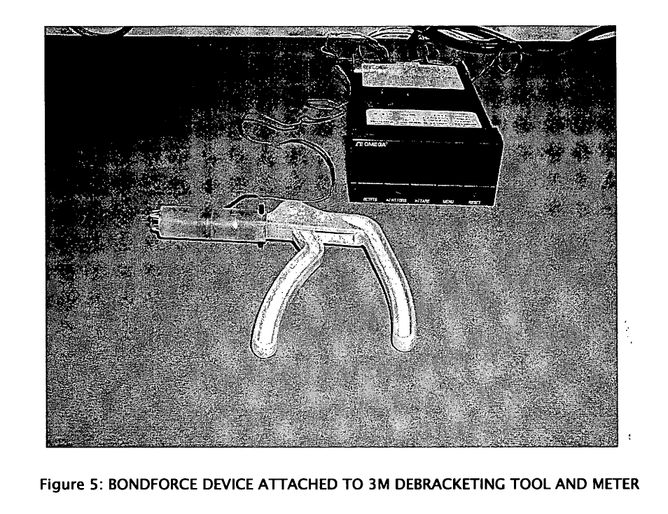

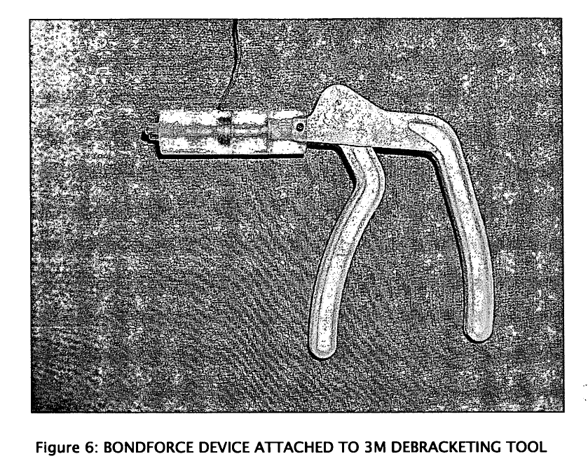

The measuring device addressed by this invention is the Bondforce handheld debonding Instrument (FIG. 1) attached to a 3M Unitek Debracketing Tool (FIG. 2), and then connected to a measuring device capable of converting millivolt readings to pounds of force. FIG. 1 shows the Bondforce device in a cutaway view (slice the device in half along a longitudinal axis). Within that view it shows that it contains a subminiature remote load cell, which measures the strain on the wire loop during debonding. The wire loop in FIG. 1 is engaged under two wings of an orthodontic bracket and the two stabilizing bars contact the tooth surface. The Bondforce device is closed slowly by squeezing the handles of the 3M Debracketing Tool in FIG. 2 and the peak force until bond failure is recorded.

What is claimed is:

1. The bonding force of an orthodontic bracket to the tooth enamel can be measured.

2. The Bondforce device described above can be used to measure the bonding force to a live tooth in the oral environment.

3. A remote subminiature load cell connected to a debonding wire loop actually measures the strain on the orthodontic bracket.

4. A meter connected to the Bondforce device converts the millivolt strain reading to human readable measurements.

5. Device has relevance in both laboratory and actual orthodontic environments.
